(19) United States
(12) Patent Application Publication
(10) Pub. No.: US 2026/0289831 A1
(43) Pub. Date: Sep. 24, 2026

(54) METHOD, DEVICE AND STORAGE MEDIUM FOR IMAGE EDITING

(71) Applicant: Beijing Zitiao Network Technology Co., Ltd., Beijing (CN)

(72) Inventor: Yang Bai, Beijing (CN)

(21) Appl. No.: 19/479,704

(22) PCT Filed: Jun. 1, 2024
(86) PCT No.: PCT/CN2024/096914

§ 371 Date: Oct. 28, 2025

(30) Foreign Application Priority Data
Jun. 1, 2023 (CN) 202310645329.2

(51) Int. Cl. G06T 11/10

(52) U.S. Cl. CPC G06T 11/10

(57) ABSTRACT

A method, device and storage medium for image editing are disclosed. In the method, an image to be edited is converted into a first color space to obtain a first image, in response to an editing instruction for the image to be edited. The first color space includes a luminance channel. The first image is adjusted in the luminance channel according to a first adjustment curve, to obtain a second image. The second image is converted into a second color space to obtain a third image. The third image is adjusted according to a second adjustment curve to obtain a target image.

This application claims priority to Chinese Patent Application No. 202310645329.2, filed on Jun. 1, 2023, and entitled “METHOD, DEVICE AND STORAGE MEDIUM FOR IMAGE EDITING”, the entire content of which is incorporated herein by reference.

### FIELD

Embodiments in the present disclosure relate to the field of computer and network communication technical, in particular to a method, device and storage medium for image editing.

### BACKGROUND

In an image editing scenario, curve adjustment is a common color adjustment method. The curve adjustment function is typically provided in various image/video color grading software for a user to perform color adjustment on the image.

When curve adjustment is applied, a one-dimensional color mapping table with a length of 256 is usually used to map the original image color to a new color value, thereby achieving the purpose of color adjustment. However, in the curve adjustment process, factors such as color, luminance, saturation and the like are typically not considered simultaneously, resulting in poor quality of color adjustment and failing to meet user requirements.

### SUMMARY

The embodiments in the present disclosure provide a method, device and storage medium for image editing, so that factors such as color, luminance and saturation may be considered simultaneously during image adjustment, improving the effect for image adjustment.

According to a first aspect, the embodiments in the present disclosure provide a method of editing an image, including: converting an image to be edited into a first color space to obtain a first image, in response to an editing instruction for the image to be edited, where the first color space includes a luminance channel; adjusting the first image in the luminance channel according to a first adjustment curve, to obtain a second image; converting the second image into a second color space to obtain a third image; and adjusting the third image according to a second adjustment curve to obtain a target image.

According to a second aspect, the embodiments in the present disclosure provide a device for editing an image, including: a conversion unit configured to convert an image to be edited into a first color space to obtain a first image, in response to an editing instruction for the image to be edited, where the first color space includes a luminance channel; a first adjustment unit configured to adjust the first image in the luminance channel according to a first adjustment curve to obtain a second image, where the conversion unit is further configured to convert the second image into a second color space to obtain a third image; and a second adjustment unit configured to adjust the third image according to a second adjustment curve to obtain a target image.

According to a third aspect, the embodiments in the present disclosure provide an electronic device, including: at least one processor and a memory; the memory storing computer executable instructions; where the at least one processor executes the computer-executable instructions stored in the memory, causing the at least one processor to perform the method for image editing according to the first aspect and various possible designs of the first aspect.

According to a fourth aspect, the embodiments in the present disclosure provide a computer-readable storage medium having computer-executable instructions stored thereon, the computer-executable instructions, when executed by a processor, implementing the method for image editing according to the first aspect and various possible designs of the first aspect.

According to a fifth aspect, the embodiments in the present disclosure provide a computer program product, including computer executable instructions, the computer-executable instructions, when executed by a processor, implementing the method for image editing according to the first aspect and various possible designs of the first aspect.

### BRIEF DESCRIPTION OF DRAWINGS

In order to more clearly illustrate the technical solutions in the embodiments of the present disclosure or the prior art, the accompanying drawings that need to be used in the description of the embodiments or the prior art will be briefly introduced below, and it is apparent that the drawings in the following description are some embodiments in the present disclosure, and those skilled in the art may also obtain other drawings based on these drawings without creative work.

FIG. 1 is an example diagram of curve adjustment in the prior art;

FIG. 2 is a schematic flowchart of a method for image editing according to an embodiment in the present disclosure;

FIG. 3 is a schematic flowchart of a method for image editing according to another embodiment in the present disclosure;

FIG. 4 is a schematic diagram of an interface for selecting a target adjustment level according to an embodiment in the present disclosure;

FIG. 5 is a schematic flowchart of a method for image editing according to another embodiment in the present disclosure;

FIG. 6 is a structural block diagram of a device for image editing according to an embodiment in the present disclosure; and

FIG. 7 is a schematic diagram of a hardware structure of an electronic device according to an embodiment in the present disclosure.

### DETAILED DESCRIPTION

In order to make the objectives, technical solutions and advantages of the embodiments in the present disclosure clearer, the technical solutions in the embodiments in the present disclosure will be clearly and completely described below with reference to the accompanying drawings in the embodiments in the present disclosure. It is apparent that the described embodiments are part of the embodiments in the present disclosure, rather than all of the embodiments. All other embodiments obtained by those skilled in the art based on the embodiments in the present disclosure without creative work should fall within the scope of the present disclosure.

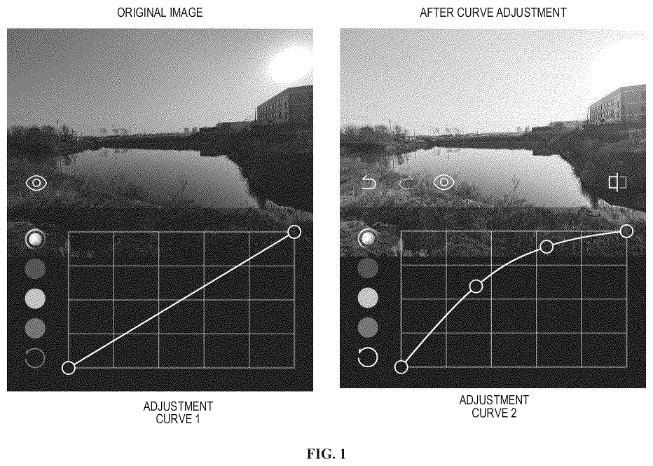

When curve adjustment is applied, a one-dimensional color mapping table (which may be represented as an adjustment curve) with a length of 256 is usually used to map the original image color to a new color value, thereby achieving the purpose of color adjustment. For example, as shown in FIG. 1, the left side illustrates an original image without adjustment (the adjustment curve 1 is y=x, where x represents the original color value, y represents the new color value after adjustment), and the right side illustrates performing curve adjustment on the original image by applying the adjustment curve 2. The respective colors of the original image are mapped according to the adjustment curve 2, the horizontal axis in the adjustment curve 2 represents the original color value and the vertical axis represents the new color value after adjustment.

However, the curve adjustment is typically performed in a single color space, especially in RGB color space. In the curve adjustment process, factors such as color, luminance, saturation and the like are typically not considered simultaneously, and the curve adjustment on the color easily causes a relatively significant change in luminance and/or saturation, which are not easy to control, resulting in poor image quality and failing to meet user requirements.

In order to solve the technical problems described above, the present disclosure provides a method of editing an image. an image to be edited being converted into a first color space to obtain a first image, in response to an editing instruction for the image to be edited, where the first color space includes a luminance channel; the first image being adjusted in the luminance channel according to a first adjustment curve, to obtain a second image; the second image being converted into a second color space to obtain a third image; and the third image being adjusted according to a second adjustment curve to obtain a target image. By performing image adjustment in dual color spaces, factors such as color, luminance, saturation and the like may be considered simultaneously, thereby improving the image adjustment effect and obtaining the image with higher quality.

The image editing method of the present disclosure is applied in an image editing scenario, and may be applied to any electronic device applicable to image editing, such as a terminal device or a server, and the terminal device is not limited to a smart phone, a tablet computer, a notebook computer, a wearable device or the like.

It should be noted that the user information (including but not limited to user equipment information, user personal information and the like) and data (including but not limited to data for analysis, stored data, displayed data and the like) involved in this application are information and data that are authorized by the user or adequately authorized by all relevant parties. The collection, use and processing of the related data should comply with relevant laws, regulations and standards of related countries and regions, and corresponding operation interface should be provided for the user to select authorization or decline.

The method for image editing of the present disclosure will be described in detail below with reference to specific embodiments.

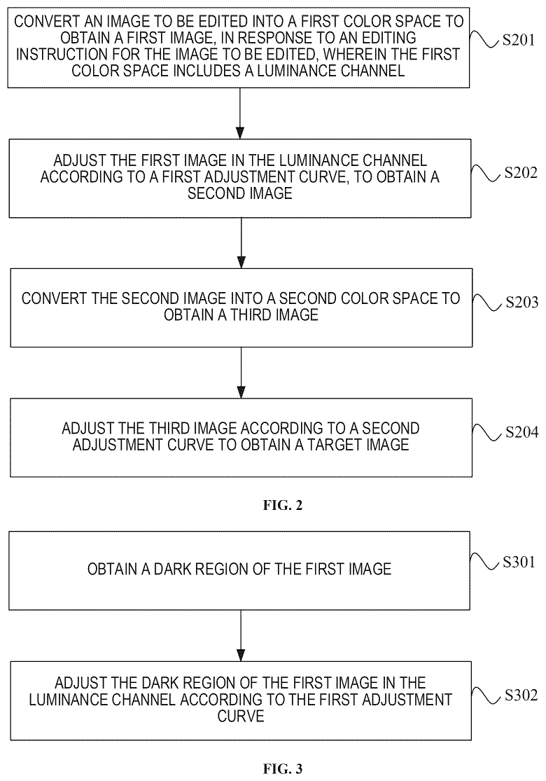

Referring to FIG. 2, FIG. 2 is a schematic flowchart of a method for image editing according to an embodiment in the present disclosure. The method of the embodiment may be applied to a terminal device or a server, and the method for image editing includes:
S201, converting an image to be edited into a first color space to obtain a first image, in response to an editing instruction for the image to be edited, where the first color space includes a luminance channel.

In the embodiment, when the user edits the image to be edited, the image to be edited may be first converted into the first color space to obtain the corresponding first image, where the first color space includes the luminance channel (or a brightness channel), so as to adjust luminance of the image on the luminance channel. The first color space includes, but is not limited to, HSV color space (Hue, Saturation, Value), HSL (Hue, Saturation, Lightness) color space, HSI (Hue, Saturation, Intensity) color space, Lab color space, and the like.

In some embodiments, since the general display device employs the RGB color space to display the image, the image to be edited may be an image captured by the user or acquired by other means and displayed, so the image to be edited may be an image of the RGB color space, and of course, the color space of the image to be edited is not limited in this embodiment. In addition, any feasible color space conversion method may be applied to convert the image to be edited into the first color space, which is not limited in the embodiment.
S202: the first image is adjusted in the luminance channel according to a first adjustment curve, to obtain a second image.

In the embodiment, after converting the image to be edited into the first image of the first color space, the curve adjustment may be performed on the first image in the luminance channel of the first color space, according to a curve which is a predetermined first adjustment curve, to obtain the second image, thereby achieving better image luminance adjustment.

Specifically, luminance channel data of the first image may be extracted, the curve adjustment may be performed on the luminance channel data based on the first adjustment curve to obtain adjusted luminance channel data, and then the adjusted luminance channel data may be replaced with the original luminance channel data of the first image.
S203: the second image is converted into a second color space to obtain a third image.

In this embodiment, in order to enable the image editing process to take factors such as luminance, color and saturation into account, after performing luminance adjustment in the first color space, the obtained second image may be converted into the second color space for color and saturation adjustment, where the second color space may be the RGB color space. Since the display device may display the image in the RGB space, the adjustment in the RGB color space may intuitively display the change before and after adjustment for the image, which is convenient for the user to view the adjustment effect, and certainly, the second color space may also be another color space. In addition, a certain degree of undersaturation may exist in the second image on which the luminance adjustment is performed in the first color space. The color and saturation may be simultaneously adjusted in the second color space to achieve the expected color and saturation adjustment effect, so that both color and saturation may be taken into account.

In this embodiment, any feasible color space conversion method may be applied to convert the second image into the second color space, which is not limited in the embodiment.
S204, the third image is adjusted according to a second adjustment curve to obtain a target image.

In the embodiment, in the second color space, the curve adjustment may be performed on the third image based on the second adjustment curve to finally obtain the target image, so as to enable the image editing process to take factors such as luminance, color, and saturation into account.

Specifically, a single second adjustment curve may be applied to adjust multiple channels of the third image in the second color space, or different adjustment curves may be applied to adjust any of one or more channels individually.

Further, the target image may be output, for example, by displaying the target image on a display device. In some embodiments, if the second color space is not the RGB color space, the target image may be further converted into the RGB color space before being displayed.

The method for image editing provided by the embodiment includes: converting an image to be edited into a first color space to obtain a first image, in response to an editing instruction for the image to be edited, where the first color space includes a luminance channel; adjusting the first image in the luminance channel according to a first adjustment curve, to obtain a second image; converting the second image into a second color space to obtain a third image; and adjusting the third image according to a second adjustment curve to obtain a target image. By performing image adjustment in the dual color spaces, factors such as color, luminance, saturation and the like may be taken into account simultaneously, thereby improving the image adjustment effect and obtaining the image with higher quality.

Based on any of the embodiments, as shown in FIG. 3, S202: adjusting the first image in the luminance channel according to a first adjustment curve, includes:
S301: obtain a dark region of the first image.
S302: adjust the dark region of the first image in the luminance channel according to the first adjustment curve.

In the embodiment, considering that the darker region may have a greater impact on visual perception, the first image may be divided into a dark region and a bright region, and only the dark region of the first image is adjusted in the luminance channel according to the first adjustment curve during the luminance adjustment process, so that the visual perception on the image may be effectively improved. Meanwhile, since the bright region tends to produce a color banding during adjustment, for example, a bright region of relatively uniform color or gradient color (for example, regions like sky, halo, and the like) tends to produce the color banding during adjustment, the luminance of the bright region is not adjusted in the embodiment, thereby avoiding the color banding in the bright region to a great extent.

In some embodiments, any feasible division method may be applied for the division of the dark region and the bright region, for example, the dark region may be obtained by applying a predetermined dark mask.

Based on the embodiments described above, S302, adjusting the dark region of the first image in the luminance channel according to the first adjustment curve may specifically include: determining a first adjustment curve for positive adjustment based on the edit instruction being a positive adjustment instruction; and increasing luminance for the dark region of the first image in the luminance channel according to the first adjustment curve; or determining a first adjustment curve for negative adjustment based on the edit instruction being a negative adjustment instruction; and decreasing luminance for the dark region of the first image in the luminance channel according to the first adjustment curve.

In the embodiment, the luminance adjustment is classified into increasing luminance and decreasing luminance based on the initial luminance, where increasing luminance is the positive adjustment on the luminance, and decreasing luminance is the negative adjustment on the luminance. Different first adjustment curves are applied in different adjustment directions, that is, the first adjustment curve may be classified into a first adjustment curve for positive adjustment and a first adjustment curve for negative adjustment. Positive adjustment or negative adjustment may be determined based on the editing instruction, and if the positive adjustment is determined, the first adjustment curve for positive adjustment may be applied to increase the luminance of the dark region of the first image in the luminance channel. If the negative adjustment is determined, the first adjustment curve for negative adjustment may be applied to decrease the luminance of the dark region of the first image in the luminance channel.

Similarly, S204, adjusting the third image according to a second adjustment curve is also classified into a positive adjustment and a negative adjustment. Different second adjustment curves are applied in different adjustment directions, that is, the second adjustment curve may be classified into a second adjustment curve for positive adjustment and a second adjustment curve for negative adjustment. Similarly, positive adjustment or negative adjustment may be determined based on the editing instruction, and if the positive adjustment is determined, the second adjustment curve for positive adjustment may be applied to adjust the third image. If the negative adjustment is determined, the second adjustment curve for negative adjustment may be applied to adjust the third image.

Based on any of the embodiments described above, since the bright region tends to produce the color banding during adjustment, when the third image is adjusted based on the second adjustment curve, the bright region of the third image may also be adjusted slightly or not adjusted as much as possible. In order to achieve the slight adjustment or no adjustment on the bright region of the third image, a curve shape of the second adjustment curve may be preconfigured, such that the portion of the second adjustment curve with a larger horizontal coordinate value (greater than a certain predetermined threshold) may have a reduced adjustment magnitude or an adjustment magnitude of 0.

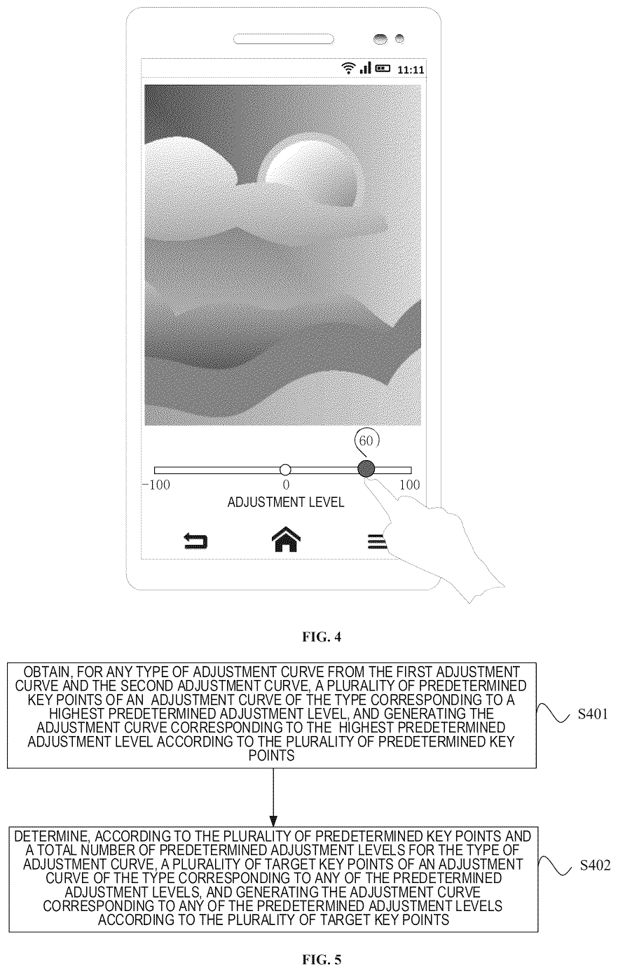

Based on the embodiments described above, in order to enable the image adjustment to achieve different degrees of adjustment effect, different adjustment curves may generally be applied. For example, when the first image is adjusted in the luminance channel based on the first adjustment curve, applying different first adjustment curves may result in different degrees of luminance adjustment effect, and when the third image is adjusted based on the second adjustment curve, applying different second adjustment curves may also result in different degrees of luminance adjustment effect. The setting of different adjustment curves has a higher degree of freedom, and if the adjustment curve is set by the user, the adjustment effect is strongly dependent on the experience of the user. The user with insufficient experience may not be able to set the adjustment curve well. Therefore, in the embodiments, different predetermined adjustment levels may be configured, and different first adjustment curves and second adjustment curves may be configured for each predetermined adjustment level. More specifically, the predetermined adjustment level may be configured separately for positive adjustment and negative adjustment. For example, positive adjustment may be divided into 100 levels, and negative adjustment may be divided into 100 levels, and different first adjustment curves and second adjustment curves may be configured for each predetermined adjustment level. Specifically, as shown in FIG. 4, the user may select a target adjustment level from the predetermined adjustment levels by a sliding control (or another control), and the first adjustment curve and the second adjustment curve corresponding to the target adjustment level may further be automatically selected.

Further, S202, prior to adjusting the first image in the luminance channel according to the first adjustment curve, the method further includes: determining a target adjustment level from a plurality of predetermined adjustment levels, in response to an adjustment level selection instruction, and then selecting a corresponding first adjustment curve and a corresponding second adjustment curve according to the target adjustment level, such that the subsequent adjustment processes may be respectively performed based on the first adjustment curve and the second adjustment curve corresponding to the target adjustment level.

Based on the embodiments described above, the different first adjustment curves and the different second adjustment curves corresponding to the different predetermined adjustment levels may be obtained in advance.

Optionally, the method for obtaining the first adjustment curves and the second adjustment curves corresponding to different predetermined adjustment levels may be the same, including that the same method applied for obtaining the first adjustment curves for positive adjustment, the first adjustment curves for negative adjustment, the second adjustment curves for positive adjustment, and the second adjustment curves for negative adjustment, each corresponding to different predetermined adjustment levels. For any type of adjustment curve corresponding to different predetermined adjustment levels, as shown in FIG. 5, the method may include:
S401, for any type of adjustment curve from the first adjustment curve and the second adjustment curve, a plurality of predetermined key points of an adjustment curve of the type corresponding to a highest predetermined adjustment level may be obtained, and the adjustment curve corresponding to the highest predetermined adjustment level may be generated according to the plurality of predetermined key points.
S402, according to the plurality of predetermined key points and a total number of predetermined adjustment levels for the type of adjustment curve, a plurality of target key points of an adjustment curve of the type corresponding to any of the predetermined adjustment levels may be determined, and the adjustment curve corresponding to any of the predetermined adjustment levels may be generated according to the plurality of target key points.

In the embodiment, for any type of the adjustment curves, the plurality of predetermined key points of the adjustment curve of the type corresponding to the highest predetermined adjustment level may be predetermined in advance, and the number of the predetermined key points may be set according to actual situation. For example, as shown in Table 1:

TABLE 1

| | Predetermined key points of | Predetermined key points of |
|---|---|---|
| | the first adjustment curve | the second adjustment curve |
| Positive | (0, 0), (x₁₁, y₁₁), (x₁₂, y₁₂), | (0, 0), (x₃₁, y₃₁), (x₃₂, y₃₂), |
| Adjustment | (x₁₃, y₁₃), (255, 255) | (x₃₃, y₃₃), (255, 255) |
| Negative | (0, 0), (x₂₁, y₂₁), (x₂₂, y₂₂), | (0, 0), (x₄₁, y₄₁), (x₄₂, y₄₂), |
| Adjustment | (x₂₃, y₂₃), (x₂₄, y₂₄), (x₂₅, | (x₄₃, y₄₃), (255, 255) |
| | y₂₅), (x₂₆, y₂₆), (255, 255) | |

The horizontal coordinate represents a value before adjustment, and the vertical coordinate represents a value after adjustment. Since the horizontal and vertical coordinates are equal in the case of no adjustment on the image, in the various adjustment curves of the embodiment, except for (0, 0) and (255, 255), the vertical coordinate values of each predetermined key point in the positive adjustment may be generally not less than the corresponding horizontal coordinate values. In the negative adjustment, the vertical coordinate values of each predetermined key point may be generally not greater than the corresponding horizontal coordinate values. Certainly, the horizontal and vertical coordinates of each predetermined key point may be set according to actual situation, and may not be limited to the foregoing rule.

Further, for the plurality of predetermined key points of the adjustment curve of any type corresponding to the highest predetermined adjustment level, a curve fitting may be performed based on the predetermined key points to generate the adjustment curve corresponding to the highest predetermined adjustment level.

For the adjustment curves corresponding to the remaining predetermined adjustment levels of the type of adjustment curve, a plurality of target key points of an adjustment curve of the type corresponding to any of the predetermined adjustment levels may be determined, based on the plurality of predetermined key points of the adjustment curve corresponding to the highest predetermined adjustment level and a total number of predetermined adjustment levels for the type of adjustment curve. Then, the curve fitting may be performed based on the target key points to generate the adjustment curve corresponding to any of the predetermined adjustment levels.

Optionally, when determining the plurality of target key points of the adjustment curve of the type corresponding to any of the predetermined adjustment levels, for any of the predetermined key points, linear interpolation between the predetermined key point and a corresponding reference point may be performed according to the total number of predetermined adjustment levels, and the target key point of the adjustment curve of the type corresponding to any of the predetermined adjustment levels may be determined. In some embodiments, the reference point corresponding to the predetermined key point may be a point on a reference curve having a same horizontal coordinate as the predetermined key point, without adjustment for the image.

In this embodiment, based on a reference curve without adjustment for the image (y=x, that is, the vertical coordinate is equal to the horizontal coordinate), a point (xⱼ,xⱼ) having the same horizontal coordinate as any predetermined key point (xⱼ,yⱼ) is selected on the reference curve. The linear interpolation is performed between the predetermined key point (xⱼ,yⱼ) and the reference point (xⱼ,xⱼ) according to the total number of predetermined adjustment levels to obtain the target key points of the adjustment curve corresponding to each predetermined adjustment level, that is, each horizontal coordinate remains xⱼ, and the vertical coordinate is evenly divided between xⱼ and yⱼ according to the total number of predetermined adjustment levels. Specifically, if the total number of the predetermined adjustment levels is n, for the i-th predetermined adjustment level, the target key point corresponding to the predetermined key points (xⱼ,yⱼ) is (xⱼ,yᵢ), and the vertical coordinate yᵢ is calculated by the following formula:

$${y}_{i} = {x}_{j} + ( i / n ) * ( {y}_{j} - {x}_{j} )$$

According to the above process, the target key point corresponding to respective predetermined key point in each predetermined adjustment level may be calculated, and then the curve fitting may be performed to generate the adjustment curve corresponding to each predetermined adjustment level.

Based on the embodiments described above, since the number of the given predetermined key points is limited, the curve fitting effect may be poor. Therefore, when S401 generating the adjustment curve corresponding to the highest predetermined adjustment level according to the plurality of predetermined key points, curve interpolation (for example, spline interpolation) may be performed between the plurality of predetermined key points, and the adjustment curve corresponding to the highest predetermined adjustment level may be generated according to interpolation points and the plurality of predetermined key points, thereby improving the curve fitting effect.

Similarly, since the number of the calculated target key points is also limited, and the curve fitting effect may be poor. Therefore, when S402 generating the adjustment curve corresponding to any of the predetermined adjustment levels according to the plurality of target key points, the curve interpolation (for example, spline interpolation) may be performed between the plurality of target key points. The adjustment curve corresponding to any of the predetermined adjustment levels may be generated according to interpolation points and the plurality of target key points.

Based on the embodiments described above, the total number of predetermined adjustment levels may be determined by the user. That is, in response to the predetermined total number of adjustment levels input by the user, the process of obtaining the different first adjustment curves and the different second adjustment curves corresponding to the different predetermined adjustment levels in the embodiments described above is performed.

The method, device and storage medium for image editing provided by the embodiment includes: converting an image to be edited into a first color space to obtain a first image, in response to an editing instruction for the image to be edited, where the first color space includes a luminance channel; adjusting the first image in the luminance channel according to a first adjustment curve, to obtain a second image; converting the second image into a second color space to obtain a third image; and adjusting the third image according to a second adjustment curve to obtain a target image. By performing image adjustment in the dual color spaces, factors such as color, luminance, saturation and the like may be taken into account simultaneously, thereby improving the image adjustment effect and obtaining the image with higher quality.

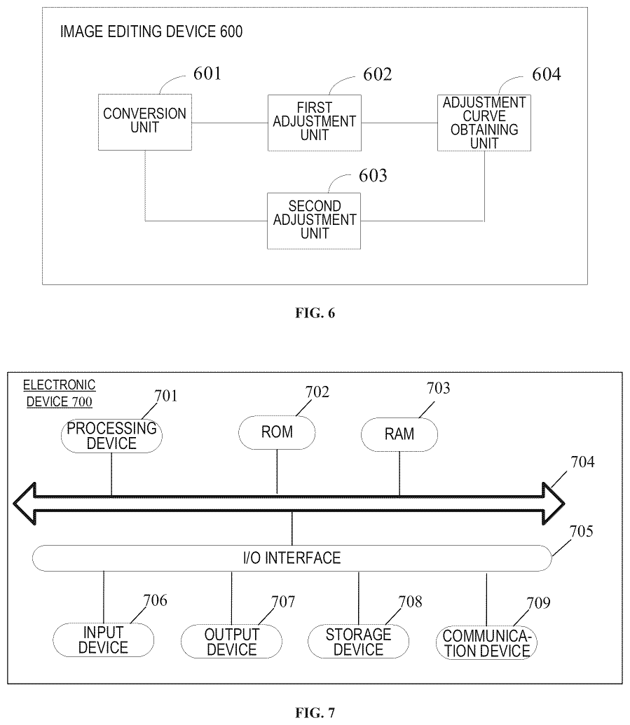

Corresponding to the image editing method of the above embodiments, FIG. 6 is a structural block diagram of a device for image editing according to an embodiment in the present disclosure. For ease of illustration, only portions related to the embodiments in the present disclosure are shown. Referring to FIG. 6, the device 600 for image editing includes a conversion unit 601, a first adjustment unit 602, and a second adjustment unit 603.

The conversion unit 601 is configured to convert an image to be edited into a first color space to obtain a first image, in response to an editing instruction for the image to be edited, where the first color space includes a luminance channel.

The first adjustment unit 602 is configured to adjust the first image in the luminance channel according to a first adjustment curve to obtain a second image.

The conversion unit 601 is further configured to convert the second image into a second color space to obtain a third image.

The second adjustment unit 603 is configured to adjust the third image according to a second adjustment curve to obtain a target image.

In one or more embodiments in the present disclosure, when the first adjustment unit 602 adjusts the first image in the luminance channel according to the first adjustment curve, the first adjustment unit 602 is configured to obtain a dark region of the first image; and adjust the dark region of the first image in the luminance channel according to the first adjustment curve.

In one or more embodiments in the present disclosure, when the first adjustment unit 602 adjusts the dark region of the first image in the luminance channel according to the first adjustment curve, the first adjustment unit 602 is configured to: determine a first adjustment curve for positive adjustment based on the edit instruction being a positive adjustment instruction; and increase luminance for the dark region of the first image in the luminance channel according to the first adjustment curve; or determine a first adjustment curve for negative adjustment based on the edit instruction being a negative adjustment instruction; and decrease luminance for the dark region of the first image in the luminance channel according to the first adjustment curve.

In one or more embodiments in the present disclosure, prior to adjusting the first image in the luminance channel according to the first adjustment curve, the first adjustment unit 602 is further configured to: determine a target adjustment level from a plurality of predetermined adjustment levels, in response to an adjustment level selection instruction, where different predetermined adjustment levels correspond to different first adjustment curves and different second adjustment curves; select a corresponding first adjustment curve according to the target adjustment level; and the second adjustment unit 603 is further configured to select a corresponding second adjustment curve according to the target adjustment level.

In one or more embodiments in the present disclosure, the device further includes: an adjustment curve obtaining unit 604, configured to obtain the different first adjustment curves and the different second adjustment curves corresponding to the different predetermined adjustment levels.

In one or more embodiments in the present disclosure, when obtaining the different first adjustment curves and the different second adjustment curves corresponding to the different predetermined adjustment levels, the adjustment curve obtaining unit 604 is configured to obtain, for any type of adjustment curve from the first adjustment curve and the second adjustment curve, a plurality of predetermined key points of an adjustment curve of the type corresponding to a highest predetermined adjustment level, and generating the adjustment curve corresponding to the highest predetermined adjustment level according to the plurality of predetermined key points; and determine, according to the plurality of predetermined key points and a total number of predetermined adjustment levels for the type of adjustment curve, a plurality of target key points of an adjustment curve of the type corresponding to any of the predetermined adjustment levels, and generating the adjustment curve corresponding to any of the predetermined adjustment levels according to the plurality of target key points.

In one or more embodiments in the present disclosure, when determining, according to the plurality of predetermined key points and the total number of predetermined adjustment levels for the type of adjustment curve, the plurality of target key points of the adjustment curve of the type corresponding to any of the predetermined adjustment levels The adjustment curve obtaining unit 604 is configured to perform, for any of the predetermined key points, linear interpolation between the predetermined key point and a corresponding reference point according to the total number of predetermined adjustment levels, and determine a target key point of the adjustment curve of the type corresponding to any of the predetermined adjustment levels, where the reference point corresponding to the predetermined key point is a point on a reference curve having a same horizontal coordinate as the predetermined key point, without adjustment for the image.

In one or more embodiments in the present disclosure, when generating the adjustment curve corresponding to the highest predetermined adjustment level according to the plurality of predetermined key points, the adjustment curve obtaining unit 604 is configured to perform curve interpolation between the plurality of predetermined key points, and generating the adjustment curve corresponding to the highest predetermined adjustment level according to interpolation points and the plurality of predetermined key points; and generate the adjustment curve corresponding to any of the predetermined adjustment levels according to the plurality of target key points includes: performing curve interpolation between the plurality of target key points, and generating the adjustment curve corresponding to any of the predetermined adjustment levels according to interpolation points and the plurality of target key points.

In one or more embodiments in the present disclosure, the first color space includes an HSV color space, an HSL color space, an HSI color space, or a Lab color space; and the second color space is an RGB color space.

The device provided in this embodiment may be configured to perform the technical solutions in the foregoing method embodiments, and implementation principles and technical effects thereof are similar, and details are not described herein again in this embodiment.

Referring to FIG. 7, FIG. 7 illustrates a schematic structural diagram of an electronic device 700 suitable for implementing the embodiments in the present disclosure, and the electronic device 700 may be a terminal device or a server. The terminal device may include, but is not limited to, a mobile terminal such as a mobile phone, a notebook computer, a digital broadcast receiver, a personal digital assistant (PDA), a portable Android device (PAD), a portable media player (PMP), an in-vehicle terminal (for example, an in-vehicle navigation terminal), as well as a fixed terminal such as a digital TV, a desktop computer, or the like. The electronic device shown in FIG. 7 is merely an example, and should not impose any limitation on the functions and usage scope of the embodiments in the present disclosure.

As shown in FIG. 7, the electronic device 700 may include a processing device 701 (for example, a central processing unit, a graphics processor, etc.), which may perform various appropriate actions and processing according to a program stored in a read only memory (ROM) 702 or a program loaded into a random access memory (RAM) 703 from a storage device 708. In the RAM 703, various programs and data required by the electronic device 700 are also stored. The processing device 701, the ROM 702, and the RAM 703 are connected to each other through a bus 704. An input/output (I/O) interface 705 is also connected to bus 704.

Generally, the following devices may be connected to the I/O interface 705: an input device 706 including, for example, a touch screen, a touch pad, a keyboard, a mouse, a camera, a microphone, an accelerometer, a gyroscope, and the like; an output device 707 including, for example, a liquid crystal display (LCD), a speaker, a vibrator, and the like; the storage device 708 including, for example, a magnetic tape, a hard disk, and the like; and a communication device 709. The communication device 709 may allow the electronic device 700 to communicate wirelessly or wired with other devices to exchange data. Although the electronic device 700 with various devices is shown in FIG. 7, it should be understood that it is not required to implement or have all illustrated devices. More or fewer devices may alternatively be implemented or provided.

In particular, according to embodiments in the present disclosure, the process described above with reference to the flowchart may be implemented as a computer software program. For example, the embodiments in the present disclosure include a computer program product including a computer program embodied on a computer readable medium, the computer program including program code for performing the method shown in the flowchart. In such embodiments, the computer program may be downloaded and installed from the network through the communication device 709, or installed from the storage device 708, or from the ROM 702. When the computer program is executed by the processing device 701, the foregoing functions defined in the method of the embodiments in the present disclosure are performed.

It should be noted that the computer-readable medium described above may be a computer readable signal medium, a computer readable storage medium, or any combination thereof. The computer-readable storage medium may be, for example, but not limited to, an electrical, magnetic, optical, electromagnetic, infrared, or semiconductor system, device, or apparatus, or any combination thereof. More specific examples of computer-readable storage media may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, the computer-readable storage medium may be any tangible medium containing or storing a program that may be used by or in connection with an instruction execution system, device, or apparatus. In the present disclosure, a computer readable signal medium may include a data signal propagated in baseband or as part of a carrier, where the computer readable program code is carried. Such propagated data signals may take various forms including, but not limited to, electromagnetic signals, optical signals, or any suitable combination thereof. The computer readable signal medium may also be any computer readable medium other than a computer readable storage medium that may send, propagate, or transmit a program for use by or in connection with an instruction execution system, device, or apparatus. The program code embodied on the computer-readable medium may be transmitted with any suitable medium, including, but not limited to: wires, optical cables, radio frequency (RF), and the like, or any suitable combination thereof.

The computer-readable medium described above may be included in the electronic device; or may be separately present without being assembled into the electronic device.

The computer-readable medium carries one or more programs, and the one or more programs, when executed by the electronic device, implement the method described in the foregoing embodiments.

The computer program code for performing the action of the present disclosure may be written in one or more programming languages or a combination thereof, including object oriented programming languages, such as Java, Smalltalk, and C++, as well as conventional procedural programming languages, such as the “C” language or similar programming languages. The program code may be executed entirely on a user computer, partially on a user computer, as a stand-alone software package, partially on a user computer, partially on a remote computer, or entirely on a remote computer or server. In the case of a remote computer, the remote computer may be connected to the user computer through any type of network, including a local area network (LAN) or a wide area network (WAN), or may be connected to an external computer (for example, via the Internet using an Internet service provider).

The flowcharts and block diagrams in the figures illustrate architecture, functionality, and operation of possible implementations of systems, methods, and computer program products according to various embodiments in the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order from that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments in the present disclosure may be implemented in software, or may be implemented in hardware. The names of the units do not constitute limitations on the units themselves. For example, the first obtaining unit may be further described as “a unit for obtaining at least two units of Internet Protocol addresses”.

The functions described above may be performed, at least in part, by one or more hardware logic components. For example of non-limiting, illustrative types of hardware logic components that may be used include: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, device, or apparatus. The machine-readable medium may be a machine-readable signal medium or a machine-readable storage medium. The machine-readable medium may include, but is not limited to, electronic, magnetic, optical, electromagnetic, infrared, or semiconductor systems, devices, or apparatus, or any suitable combination thereof. More specific examples of machine-readable storage media may include electrical connections based on one or more wires, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

In the first aspect, according to one or more embodiments in the present disclosure, a method of editing an image is provided, including: converting an image to be edited into a first color space to obtain a first image, in response to an editing instruction for the image to be edited, where the first color space includes a luminance channel; adjusting the first image in the luminance channel according to a first adjustment curve, to obtain a second image; converting the second image into a second color space to obtain a third image; and adjusting the third image according to a second adjustment curve to obtain a target image.

According to one or more embodiments in the present disclosure, adjusting the first image in the luminance channel according to the first adjustment curve includes: obtaining a dark region of the first image; and adjusting the dark region of the first image in the luminance channel according to the first adjustment curve.

According to one or more embodiments in the present disclosure, adjusting the dark region of the first image in the luminance channel according to the first adjustment curve includes: determining a first adjustment curve for positive adjustment based on the edit instruction being a positive adjustment instruction; and increasing luminance for the dark region of the first image in the luminance channel according to the first adjustment curve; or determining a first adjustment curve for negative adjustment based on the edit instruction being a negative adjustment instruction; and decreasing luminance for the dark region of the first image in the luminance channel according to the first adjustment curve.

According to one or more embodiments in the present disclosure, prior to adjusting the first image in the luminance channel according to the first adjustment curve, the method further includes: determining a target adjustment level from a plurality of predetermined adjustment levels, in response to an adjustment level selection instruction, where different predetermined adjustment levels correspond to different first adjustment curves and different second adjustment curves; and selecting a corresponding first adjustment curve and a corresponding second adjustment curve, according to the target adjustment level.

According to one or more embodiments in the present disclosure, the method further includes: obtaining the different first adjustment curves and the different second adjustment curves corresponding to the different predetermined adjustment levels.

According to one or more embodiments in the present disclosure, obtaining the different first adjustment curves and the different second adjustment curves corresponding to the different predetermined adjustment levels includes: obtaining, for any type of adjustment curve from the first adjustment curve and the second adjustment curve, a plurality of predetermined key points of an adjustment curve of the type corresponding to a highest predetermined adjustment level, and generating the adjustment curve corresponding to the highest predetermined adjustment level according to the plurality of predetermined key points; and determining, according to the plurality of predetermined key points and a total number of predetermined adjustment levels for the type of adjustment curve, a plurality of target key points of an adjustment curve of the type corresponding to any of the predetermined adjustment levels, and generating the adjustment curve corresponding to any of the predetermined adjustment levels according to the plurality of target key points.

According to one or more embodiments in the present disclosure, determining, according to the plurality of predetermined key points and the total number of predetermined adjustment levels for the type of adjustment curve, the plurality of target key points of the adjustment curve of the type corresponding to any of the predetermined adjustment levels includes: performing, for any of the predetermined key points, linear interpolation between the predetermined key point and a corresponding reference point according to the total number of predetermined adjustment levels, and determine a target key point of the adjustment curve of the type corresponding to any of the predetermined adjustment levels, where the reference point corresponding to the predetermined key point is a point on a reference curve having a same horizontal coordinate as the predetermined key point, without adjustment for the image.

According to one or more embodiments in the present disclosure, generating the adjustment curve corresponding to the highest predetermined adjustment level according to the plurality of predetermined key points includes: performing curve interpolation between the plurality of predetermined key points, and generating the adjustment curve corresponding to the highest predetermined adjustment level according to interpolation points and the plurality of predetermined key points; and generating the adjustment curve corresponding to any of the predetermined adjustment levels according to the plurality of target key points includes: performing curve interpolation between the plurality of target key points, and generating the adjustment curve corresponding to any of the predetermined adjustment levels according to interpolation points and the plurality of target key points.

According to one or more embodiments in the present disclosure, the first color space includes an HSV color space, an HSL color space, an HSI color space, or a Lab color space; and the second color space is an RGB color space.

In the second aspect, according to one or more embodiments in the present disclosure, a device for editing an image is provided, including: a conversion unit configured to convert an image to be edited into a first color space to obtain a first image, in response to an editing instruction for the image to be edited, where the first color space includes a luminance channel; a first adjustment unit configured to adjust the first image in the luminance channel according to a first adjustment curve to obtain a second image, where the conversion unit is further configured to convert the second image into a second color space to obtain a third image; and a second adjustment unit configured to adjust the third image according to a second adjustment curve to obtain a target image.

According to one or more embodiments in the present disclosure, when the first adjustment unit adjusts the first image in the luminance channel according to the first adjustment curve, the first adjustment unit is configured to obtain a dark region of the first image; and adjust the dark region of the first image in the luminance channel according to the first adjustment curve.

According to one or more embodiments in the present disclosure, when the first adjustment unit adjusts the dark region of the first image in the luminance channel according to the first adjustment curve, the first adjustment unit is configured to: determine a first adjustment curve for positive adjustment based on the edit instruction being a positive adjustment instruction; and increase luminance for the dark region of the first image in the luminance channel according to the first adjustment curve; or determine a first adjustment curve for negative adjustment based on the edit instruction being a negative adjustment instruction; and decrease luminance for the dark region of the first image in the luminance channel according to the first adjustment curve.

According to one or more embodiments in the present disclosure, prior to adjusting the first image in the luminance channel according to the first adjustment curve, the first adjustment unit is further configured to: determine a target adjustment level from a plurality of predetermined adjustment levels, in response to an adjustment level selection instruction, where different predetermined adjustment levels correspond to different first adjustment curves and different second adjustment curves; select a corresponding first adjustment curve according to the target adjustment level; and the second adjustment unit is further configured to select a corresponding second adjustment curve according to the target adjustment level.

According to one or more embodiments in the present disclosure, the device further includes: an adjustment curve obtaining unit, configured to obtain the different first adjustment curves and the different second adjustment curves corresponding to the different predetermined adjustment levels.

According to one or more embodiments in the present disclosure, when obtaining the different first adjustment curves and the different second adjustment curves corresponding to the different predetermined adjustment levels, the adjustment curve obtaining unit is configured to obtain, for any type of adjustment curve from the first adjustment curve and the second adjustment curve, a plurality of predetermined key points of an adjustment curve of the type corresponding to a highest predetermined adjustment level, and generating the adjustment curve corresponding to the highest predetermined adjustment level according to the plurality of predetermined key points; and determine, according to the plurality of predetermined key points and a total number of predetermined adjustment levels for the type of adjustment curve, a plurality of target key points of an adjustment curve of the type corresponding to any of the predetermined adjustment levels, and generating the adjustment curve corresponding to any of the predetermined adjustment levels according to the plurality of target key points.

According to one or more embodiments in the present disclosure, when determining, according to the plurality of predetermined key points and the total number of predetermined adjustment levels for the type of adjustment curve, the plurality of target key points of the adjustment curve of the type corresponding to any of the predetermined adjustment levels, the adjustment curve obtaining unit is configured to perform, for any of the predetermined key points, linear interpolation between the predetermined key point and a corresponding reference point according to the total number of predetermined adjustment levels, and determine a target key point of the adjustment curve of the type corresponding to any of the predetermined adjustment levels, where the reference point corresponding to the predetermined key point is a point on a reference curve having a same horizontal coordinate as the predetermined key point, without adjustment for the image.

According to one or more embodiments in the present disclosure, when generating the adjustment curve corresponding to the highest predetermined adjustment level according to the plurality of predetermined key points, the adjustment curve obtaining unit is configured to perform curve interpolation between the plurality of predetermined key points, and generating the adjustment curve corresponding to the highest predetermined adjustment level according to interpolation points and the plurality of predetermined key points; and generate the adjustment curve corresponding to any of the predetermined adjustment levels according to the plurality of target key points includes: performing curve interpolation between the plurality of target key points, and generating the adjustment curve corresponding to any of the predetermined adjustment levels according to interpolation points and the plurality of target key points.

According to one or more embodiments in the present disclosure, the first color space includes an HSV color space, an HSL color space, an HSI color space, or a Lab color space; and the second color space is an RGB color space.

In the third aspect, according to one or more embodiments in the present disclosure, an electronic device is provided, including: at least one processor and a memory; the memory storing computer executable instructions; where the at least one processor executes the computer-executable instructions stored in the memory, causing the at least one processor to perform the method for image editing according to the first aspect and the possible designs of the first aspect.

In the forth aspect, according to one or more embodiments in the present disclosure, a computer-readable storage medium is provided, having computer-executable instructions stored thereon, the computer-executable instructions, when executed by a processor, implementing the method for image editing according to the first aspect and the possible designs of the first aspect.

In the fifth aspect, according to one or more embodiments in the present disclosure, a computer program product is provided, including computer executable instructions, the computer-executable instructions, when executed by a processor, implementing the method for image editing according to the first aspect and the possible designs of the first aspect.

The above description is merely an illustration of the preferred embodiments in the present disclosure and the principles of the applied technology. It should be understood by those skilled in the art that the scope of the present disclosure is not limited to the technical solutions of the specific combination of the above technical features, and should also cover other technical solutions formed by any combination of the above technical features or their equivalent features without departing from the above disclosed concept. For example, technical solutions formed by replacing the above features with technical features having similar functions as disclosed (but not limited to those disclosed) in the present disclosure are also included.

Further, although operations are depicted in a particular order, this should not be understood to require that these operations be performed in the particular order shown or in sequential order. In certain circumstances, multitasking and parallel processing may be advantageous. Likewise, although several specific implementation details are included in the above discussion, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely illustrative forms of implementing the claims.

Please amend the claims as reflected in the following marked-up version:

1. A method of editing an image, comprising:
converting an image to be edited into a first color space to obtain a first image, in response to an editing instruction for the image to be edited, wherein the first color space comprises a luminance channel;
adjusting the first image in the luminance channel according to a first adjustment curve, to obtain a second image;
converting the second image into a second color space to obtain a third image; and
adjusting the third image according to a second adjustment curve to obtain a target image.

2. The method of claim 1, wherein adjusting the first image in the luminance channel according to the first adjustment curve comprises:
obtaining a dark region of the first image; and
adjusting the dark region of the first image in the luminance channel according to the first adjustment curve.

3. The method of claim 2, wherein adjusting the dark region of the first image in the luminance channel according to the first adjustment curve comprises:
determining a first adjustment curve for positive adjustment based on the edit instruction being a positive adjustment instruction; and increasing luminance for the dark region of the first image in the luminance channel according to the first adjustment curve; or
determining a first adjustment curve for negative adjustment based on the edit instruction being a negative adjustment instruction; and decreasing luminance for the dark region of the first image in the luminance channel according to the first adjustment curve.

4. The method of claim 1, wherein prior to adjusting the first image in the luminance channel according to the first adjustment curve, the method further comprises:
determining a target adjustment level from a plurality of predetermined adjustment levels, in response to an adjustment level selection instruction, wherein different predetermined adjustment levels correspond to different first adjustment curves and different second adjustment curves; and
selecting a corresponding first adjustment curve and a corresponding second adjustment curve, according to the target adjustment level.

5. The method of claim 4, further comprising:
obtaining the different first adjustment curves and the different second adjustment curves corresponding to the different predetermined adjustment levels.

6. The method of claim 5, wherein obtaining the different first adjustment curves and the different second adjustment curves corresponding to the different predetermined adjustment levels comprises:
obtaining, for any type of adjustment curve from the first adjustment curve and the second adjustment curve, a plurality of predetermined key points of an adjustment curve of the type corresponding to a highest predetermined adjustment level, and generating the adjustment curve corresponding to the highest predetermined adjustment level according to the plurality of predetermined key points; and
determining, according to the plurality of predetermined key points and a total number of predetermined adjustment levels for the type of adjustment curve, a plurality of target key points of an adjustment curve of the type corresponding to any of the predetermined adjustment levels, and generating the adjustment curve corresponding to any of the predetermined adjustment levels according to the plurality of target key points.

7. The method of claim 6, wherein determining, according to the plurality of predetermined key points and the total number of predetermined adjustment levels for the type of adjustment curve, the plurality of target key points of the adjustment curve of the type corresponding to any of the predetermined adjustment levels comprises:
performing, for any of the predetermined key points, linear interpolation between the predetermined key point and a corresponding reference point according to the total number of predetermined adjustment levels, and determining a target key point of the adjustment curve of the type corresponding to any of the predetermined adjustment levels, wherein the reference point corresponding to the predetermined key point is a point on a reference curve having a same horizontal coordinate as the predetermined key point, without adjustment for the image.

8. The method of claim 6, wherein generating the adjustment curve corresponding to the highest predetermined adjustment level according to the plurality of predetermined key points comprises:
performing curve interpolation between the plurality of predetermined key points, and generating the adjustment curve corresponding to the highest predetermined adjustment level according to interpolation points and the plurality of predetermined key points; and
generating the adjustment curve corresponding to any of the predetermined adjustment levels according to the plurality of target key points comprises:
performing curve interpolation between the plurality of target key points, and generating the adjustment curve corresponding to any of the predetermined adjustment levels according to interpolation points and the plurality of target key points.

9. The method of claim 1, wherein the first color space comprises an HSV color space, an HSL color space, an HSI color space, or a Lab color space; and the second color space is an RGB color space.

10. (canceled)

11. An electronic device, comprising: at least one processor and a memory;
the memory storing computer executable instructions;
wherein the at least one processor executes the computer-executable instructions stored in the memory, causing the at least one processor to perform acts comprising:
converting an image to be edited into a first color space to obtain a first image, in response to an editing instruction for the image to be edited, wherein the first color space comprises a luminance channel;
adjusting the first image in the luminance channel according to a first adjustment curve, to obtain a second image;
converting the second image into a second color space to obtain a third image; and
adjusting the third image according to a second adjustment curve to obtain a target image.

12. A non-transitory computer-readable storage medium having computer-executable instructions stored thereon, the computer-executable instructions, when executed by a processor, implementing acts comprising:
converting an image to be edited into a first color space to obtain a first image, in response to an editing instruction for the image to be edited, wherein the first color space comprises a luminance channel;
adjusting the first image in the luminance channel according to a first adjustment curve, to obtain a second image;
converting the second image into a second color space to obtain a third image; and
adjusting the third image according to a second adjustment curve to obtain a target image.

13. (canceled)

14. The electronic device of claim 11, wherein adjusting the first image in the luminance channel according to the first adjustment curve comprises:
obtaining a dark region of the first image; and
adjusting the dark region of the first image in the luminance channel according to the first adjustment curve.

15. The electronic device of claim 14, wherein adjusting the dark region of the first image in the luminance channel according to the first adjustment curve comprises:
determining a first adjustment curve for positive adjustment based on the edit instruction being a positive adjustment instruction; and increasing luminance for the dark region of the first image in the luminance channel according to the first adjustment curve; or
determining a first adjustment curve for negative adjustment based on the edit instruction being a negative adjustment instruction; and decreasing luminance for the dark region of the first image in the luminance channel according to the first adjustment curve.

16. The electronic device of claim 11, wherein prior to adjusting the first image in the luminance channel according to the first adjustment curve, the acts further comprises:
determining a target adjustment level from a plurality of predetermined adjustment levels, in response to an adjustment level selection instruction, wherein different predetermined adjustment levels correspond to different first adjustment curves and different second adjustment curves; and
selecting a corresponding first adjustment curve and a corresponding second adjustment curve, according to the target adjustment level.

17. The electronic device of claim 16, the acts further comprising:
obtaining the different first adjustment curves and the different second adjustment curves corresponding to the different predetermined adjustment levels.

18. The electronic device of claim 17, wherein obtaining the different first adjustment curves and the different second adjustment curves corresponding to the different predetermined adjustment levels comprises:
obtaining, for any type of adjustment curve from the first adjustment curve and the second adjustment curve, a plurality of predetermined key points of an adjustment curve of the type corresponding to a highest predetermined adjustment level, and generating the adjustment curve corresponding to the highest predetermined adjustment level according to the plurality of predetermined key points; and
determining, according to the plurality of predetermined key points and a total number of predetermined adjustment levels for the type of adjustment curve, a plurality of target key points of an adjustment curve of the type corresponding to any of the predetermined adjustment levels, and generating the adjustment curve corresponding to any of the predetermined adjustment levels according to the plurality of target key points.

19. The electronic device of claim 18, wherein determining, according to the plurality of predetermined key points and the total number of predetermined adjustment levels for the type of adjustment curve, the plurality of target key points of the adjustment curve of the type corresponding to any of the predetermined adjustment levels comprises:
performing, for any of the predetermined key points, linear interpolation between the predetermined key point and a corresponding reference point according to the total number of predetermined adjustment levels, and determining a target key point of the adjustment curve of the type corresponding to any of the predetermined adjustment levels, wherein the reference point corresponding to the predetermined key point is a point on a reference curve having a same horizontal coordinate as the predetermined key point, without adjustment for the image.

20. The electronic device of claim 18, wherein generating the adjustment curve corresponding to the highest predetermined adjustment level according to the plurality of predetermined key points comprises:
performing curve interpolation between the plurality of predetermined key points, and generating the adjustment curve corresponding to the highest predetermined adjustment level according to interpolation points and the plurality of predetermined key points; and
generating the adjustment curve corresponding to any of the predetermined adjustment levels according to the plurality of target key points comprises:
performing curve interpolation between the plurality of target key points, and generating the adjustment curve corresponding to any of the predetermined adjustment levels according to interpolation points and the plurality of target key points.

21. The electronic device of claim 11, wherein the first color space comprises an HSV color space, an HSL color space, an HSI color space, or a Lab color space; and the second color space is an RGB color space.

22. The non-transitory computer-readable storage medium of claim 12, wherein adjusting the first image in the luminance channel according to the first adjustment curve comprises:
obtaining a dark region of the first image; and
adjusting the dark region of the first image in the luminance channel according to the first adjustment curve.
